(19) United States
(12) Patent Application Publication
(10) Pub. No.: US 2017/0172106 A1
(43) Pub. Date: Jun. 22, 2017

(54) PET COMB HAVING AN INTEGRAL CAPTURE SURFACE

(71) Applicant: Helen Koursiotis, Port Richey, FL (US)

(72) Inventor: Helen Koursiotis, Port Richey, FL (US)

(21) Appl. No.: 14/975,600

(22) Filed: Dec. 18, 2015

(51) Int. Cl. A01K 13/00

(52) U.S. Cl. CPC A01K 13/002

(57) ABSTRACT

A modified pet comb for mechanically removing parasitic pests from the skin and fur of an animal includes a shaft member defining a rigid portion which is shaped and positioned to provide a surface that can be grasped by a user's hand, a capture surface for capturing parasitic pests on contact, and a plurality of teeth for directing such pests to the capture surface while being passed along the skin and/or through the fur of an animal. The modified pet comb configured to be run through the fur of an animal in a cleaning direction and cause any pests present in such fur to be caught by the teeth and directed up the teeth towards the shaft where they then captured by the capture surface by adhering thereto on contact.

### BACKGROUND OF THE INVENTION

Field of the Invention

This invention relates generally to grooming devices and, more particularly, to a pet combing device which includes a removable adhesive surface integrated therewith.

Description of the Prior Art

For those who own and/or care for pets and other domestic animals, there are many well established products and procedures to prevent and/or treat an infestation of parasitic pests, such as fleas and ticks. Common prevention and treatment systems range from mechanical devices such as vacuums to chemical treatments which utilize pesticides. Nonetheless, there remains a need for a pet comb having an integral capture surface which would ease the mechanical removal of parasitic pests from the hair or fur (collectively referred to herein as “fur”) of an animal. It would be helpful if such a pet comb having an integral capture surface included a pest capturing surface disposed at the base of its teeth so as to forcibly retain any pest that it contacts. It would be additionally desirable for such a pet comb having an integral capture surface to include slightly angled teeth so as to direct pests in the fur of an animal being treated to the pest capturing surface.

The Applicant's invention described herein provides for a pet comb having an integral capture surface adapted to capture pests present on an area of animal skin or fur whenever the device is passed along the skin, through the fur of an animal. The primary components of Applicant's pet comb having an integral capture surface are a shaft, a capture surface, and a plurality of teeth. When in operation, the pet comb having an integral capture surface enables more effective and efficient mechanical removal of pests from an animal. As a result, many of the limitations imposed by prior art structures are removed.

### SUMMARY OF THE INVENTION

A modified pet comb for mechanically removing parasitic pests from the skin and fur of an animal. The modified pet comb comprises a shaft member defining a rigid portion which is shaped and positioned to provide a surface that can be grasped by a user's hand, a capture surface for capturing parasitic pests on contact, and a plurality of teeth for directing such pests to the capture surface while being passed along the skin and/or through the fur of an animal. The modified pet comb configured to be run through the fur of an animal in a cleaning direction and cause any pests present in such fur to be caught by the teeth and directed up the teeth towards the shaft where they then captured by the capture surface by adhering thereto on contact.

It is an object of this invention to provide a pet comb having an integral capture surface which would ease the mechanical removal of parasitic pests from the hair or fur of an animal.

It is another object of this invention to provide a pet comb having an integral capture surface which includes a pest capturing surface disposed at the base of its teeth so as to forcibly retain any pest that it contacts.

It is yet another object of this invention to provide a pet comb having an integral capture surface to include slightly angled teeth so as to direct pests in the fur of an animal being treated to the pest capturing surface.

These and other objects will be apparent to one of skill in the art.

### BRIEF DESCRIPTION OF THE DRAWINGS

FIG. 1 is a front elevational view of a pet comb having an integral capture surface built in accordance with the present invention.

FIG. 2 is a side elevational view of a pet comb having an integral capture surface built in accordance with the present invention.

### DETAILED DESCRIPTION OF THE INVENTION

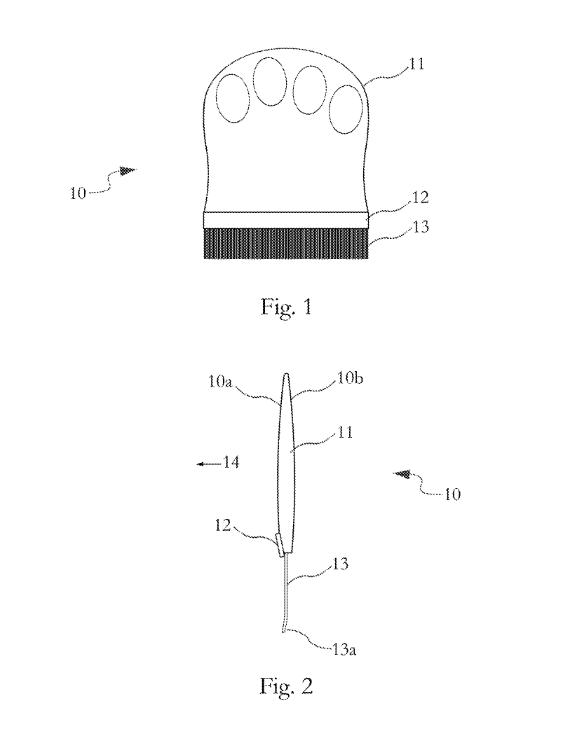

Referring now to the drawings and in particular FIGS. 1 and 2, a modified pet comb 10 which includes an integral capture surface is shown as a shaft member 11, a capture surface 12, and a plurality of teeth 13. In the preferred embodiment, the pet comb 10 defines a substantially planar body that includes a front side 10a and a rear side 10b, with the shaft member 11 and the plurality of teeth 13 constructed in a similar manner to conventional combs. In this regard, the shaft member 11 defines a rigid portion which is shaped and positioned to provide a surface that can be grasped by a users hand, thereby enabling the user to hold and manipulate the modified pet comb 10.

Attached to and extending from the shaft member 11 are the plurality of teeth 13. Generally, each tooth 13 which comprises the plurality of teeth 13 defining discrete, elongated rods arranged in parallel. In illustrated embodiment, the teeth 13 are sized and arranged in a manner which defines a fine tooth comb. It is contemplated, however, that in alternate embodiments, the teeth 13 may include wider teeth or both fine teeth and wide teeth.

In the preferred embodiment, each of teeth 13 include a distal end 13a which is slightly curved. In other embodiments, the teeth 13 are linear.

Disposed on the shaft 11, directly above where the teeth 13 extend therefrom is capture surface 12. In the preferred embodiment, the capture surface 12 defines a dual sided adhesive tape which is removably attached to the shaft 11, positioned such that it is contiguous with the teeth 13 and extends up the shaft 11 on the front side 10a of the modified comb 10. Through the positioning of the capture surface 12 and the angled shape of the teeth 13, when the modified pet comb 10 is run through the fur of an aninaml in a cleaning direction 14, any pests present in such fur are caught by the teeth 13 and directed up the teeth 13 towards the shaft 11 where they then captured by the capture surface 12 by adhering thereto on contact.

Notably, if the teeth 13 are placed in contact with the skin of an animal when running the comb 10 through the fur of an animal, parasitic pests on the skin of the animal can similarly be dislodged, caught, and captured.

It is appreciated as that in embodiments where the capture surface 12 is removably attached to the shaft 11, a used capture surface 12 can be removed and replaced with another capture surface 12 so as to provide for repeated use of the modified pet comb.

It is contemplated that in some embodiments of the present invention, the teeth may be straight and/or the capture surface may be present in both sides of the pet comb.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A modified pet comb for mechanically removing parasitic pests from the skin and fur of an animal, comprising:
a shaft member having a first side and defining a rigid portion adapted to be grasped by a user's hand;
a plurality of teeth attached to and extending in parallel from the shaft member, wherein the teeth are operative to catch pests present in at least one of the skin of an animal when passed against the skin and the fur of an animal when passed through the fur; and
a capture surface integral with the shaft member, wherein said capture surface is adapted to capture pests caught by the teeth on contact.

2. The modified pet comb of claim 1, wherein the teeth each include an angled end oriented towards first side.

3. The modified pet comb of claim 2, wherein the capture surface first side is positioned on the first side.

4. The modified pet comb of claim 1, wherein the capture surface positioned adjacent to said teeth.

5. The modified pet comb of claim 1, wherein the capture surface is removably attached to said shaft member.

6. The modified pet comb of claim 1, wherein the capture surface defines an adhesive surface.

7. A modified pet comb for mechanically removing parasitic pests from the skin and fur of an animal, comprising:
a shaft member having a first side and defining a rigid portion adapted to be grasped by a user's hand;
a plurality of teeth attached to and extending in parallel from the shaft member, wherein the teeth are operative to catch pests present in at least one of the skin of an animal when passed against the skin and the fur of an animal when passed through the fur;
said teeth each including an angled distal end oriented towards first side; and
a capture surface integral with the first side of the shaft member, wherein said capture surface is adapted to capture pests caught by the teeth on contact.

8. The modified pet comb of claim 7, wherein the capture surface positioned adjacent to said teeth.

9. The modified pet comb of claim 8, wherein the capture surface is removably attached to said shaft member.

10. The modified pet comb of claim 8, wherein the capture surface defines an adhesive surface.
